(19) United States
(12) Patent Application Publication
(10) Pub. No.: US 2023/0025473 A1
(43) Pub. Date: Jan. 26, 2023

(54) Beverage-making machine

(71) Applicant: Giulio MACRO, Binasco MI (IT)

(72) Inventor: Giulio MACRO, Binasco MI (IT)

(73) Assignee: Gruppo Cimbali S.p.A., Binasco MI (IT)

(21) Appl. No.: 17/860,482

(22) Filed: Jul. 8, 2022

(30) Foreign Application Priority Data
Jul. 15, 2021 (IT) 102021000018791

(51) Int. Cl. A47J 31/44; A47J 31/46

(52) U.S. Cl. CPC A47J 31/4403; A47J 31/46

(57) ABSTRACT

A beverage-making machine comprising: an outer casing, a beverage dispensing unit, and a tray. The tray comprises: a vessel for collecting waste liquids, which comprises a bottom and a plurality of sides defining a peripheral edge; a movable support configured to support a container adapted to receive the beverage being dispensed, and comprising a flat portion, walls and a first and a second bearing portion; attachment members for removably attaching the movable support to the vessel. The movable support reversibly alternates between a raised configuration, in which the first bearing portion of the movable support contacts the peripheral edge of the vessel and the attachment members are attached, and a lowered configuration, in which the second bearing portion of the movable support contacts the peripheral edge of the vessel.

The present invention relates to a beverage-making machine. The beverage machine is designed for both professional and home use in making beverages, such as espresso, tea or cappuccino.

Beverage-making machines are known in the art which have components designed to adjust the distance between the dispensing unit and the container adapted to receive the beverage from the dispensing unit.

EP3096659A1 discloses a beverage dispenser comprising a drip plate. The beverage dispenser comprises female connection members which are coupled with respective male connection members of the drip plate. The drip plate assembly comprises a plurality of female connectors, at different heights to keep the drip plate at a desired distance from a beverage dispenser. Furthermore a locking mechanism is provided to lock the plate to the beverage dispenser in view of increasing its stability.

CN203436182U discloses a device for changing the position of a cup between a high position and a low position. The device comprises a positioning plate which, in the low position, has a cavity facing a beverage dispenser. The bottom of the cup rests on the bottom of the cavity. In the high configuration, the positioning plate cavity faces away from the beverage dispenser. High-low position switching is made by rotating the positioning plate.

One drawback of the beverage dispenser of EP3096659A1 is that it is impractical, especially for professional use. The beverage-making process is slowed down because the coupling of the male connection member with the female connection member may require multiple attempts, in particular if there are more than one connection member. The locking mechanism further slows down the beverage making speed as a user is required move the locking mechanism at each height change. In addition, the plate is not supported along the support base and may thus be broken upon engagement of the male connection member.

In CN203436182U the device for changing the position of a container has an aesthetic impact on the beverage-making machine on which it is applied. Furthermore, a user might use the device with a cup having a wrong size. Finally, the device can be used with one cup at a time, which slows down the beverage-making process.

### SUMMARY OF THE INVENTION

Therefore, the technical purpose of the present invention is to provide a beverage-making machine that can obviate the above mentioned prior art drawbacks.

In particular, the present invention has the object to provide a beverage-making machine that allows a beverage container to be conveniently placed at a desired distance from a beverage dispenser.

The aforementioned technical purpose and objects are substantially fulfilled by a beverage-making machine that comprises the technical features as disclosed in one or more of the accompanying claims.

In particular, a beverage-making machine comprises an outer casing, a beverage dispensing unit and a tray arranged below the beverage dispensing unit.

The tray comprises a vessel for collecting waste liquids, a movable support and attachment members.

The vessel comprises a bottom, a plurality of sides projecting from the bottom, which define a peripheral edge and support structures arranged on the bottom.

The attachment members are configured to removably attach the movable support to the vessel.

The movable support is configured to support a container adapted to receive the beverage dispensed by the beverage dispensing unit and comprises a a flat portion, walls projecting from the flat portion and a first and a second bearing portion.

The movable support reversibly alternates between a raised configuration, in which the first bearing portion contacts the peripheral edge of the vessel and the attachment members are attached; and a lowered configuration, in which the second bearing portion of the movable support contacts the peripheral edge of the vessel.

The above described beverage-making machine solves the technical problem by including a tray that can be quickly adjusted. This is possible because the attachment members can be easily attached and the support portions provide stability to the movable support. In addition, the tray may be employed on existing beverage-making machines. Finally, the tray has no aesthetic impact on the product and is functional as it allows a user to operate on a plurality of containers during the beverage-making process.

### LIST OF FIGURES

Further features and advantages of the present invention will result more clearly from the illustrative, non-limiting description of a preferred, non-exclusive embodiment of a beverage-making machine as shown in the annexed drawings, in which:

FIG. 1 is a front view of the beverage-making machine of the present invention;

FIG. 2 is a cross-sectional perspective view of a tray in a raised configuration;

FIG. 3 is a cross-sectional perspective view of the tray of FIG. 2 in a lowered configuration;

FIG. 4 is a perspective view of a vessel of the tray of FIGS. 2 and 3;

FIG. 5 is a perspective view of a movable support of the tray of FIGS. 2 and 3;

FIG. 6 is a cross-sectional perspective view of the tray in the raised configuration of FIG. 2, where the movable support is engaged with a small container.

FIG. 7 is a cross sectional perspective view of the tray in the lowered configuration of FIG. 3, where the movable support is engaged with a large container.

### DETAILED DESCRIPTION

Referring to the accompanying figures, numeral 1 designates a beverage-making machine according to the present invention.

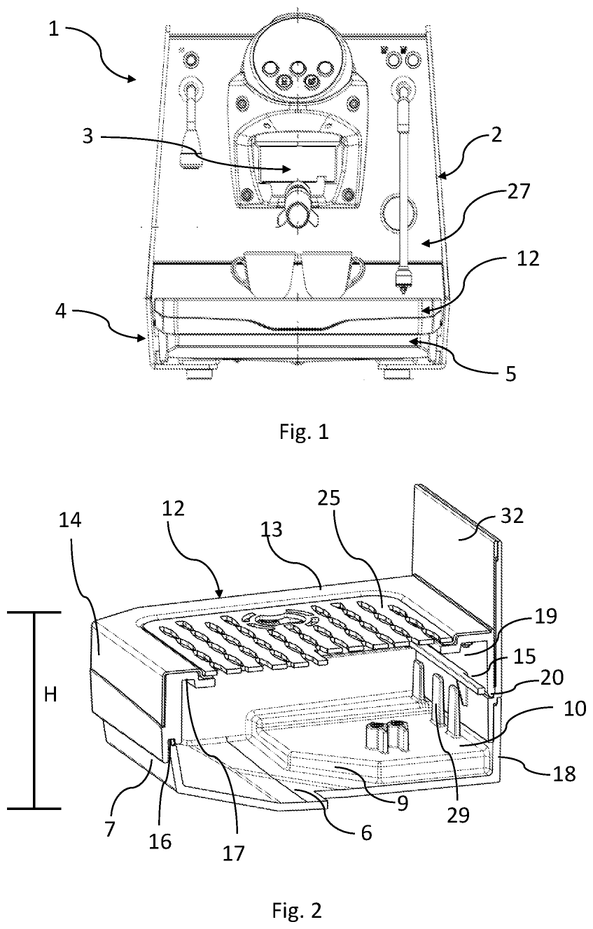

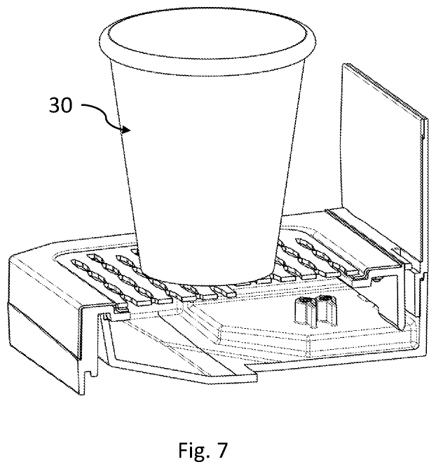

The beverage-making machine 1 as shown in FIG. 1, comprises an outer casing 2, a beverage dispensing unit 3 located on a surface 27 of the outer casing 2, and a tray 4 located below the beverage dispensing unit 3. The beverage-making machine 1 can be conveniently used with containers adapted to receive the beverage being dispensed, such as those as shown in FIG. 6 and FIG. 7.

The tray 4 comprises a vessel 5 and a mobile support 12.

The vessel 5 is shown in FIG. 4 and has the purpose to collect waste liquids from the beverage dispensing unit 3 or from the container adapted to receive the beverage being dispensed. The vessel 5 comprises a bottom 6 comprising: a flat part 21, facing the beverage-making machine 1; drain channels 23, located on the flat part 21 and configured to channel waste liquids to a collection vessel, not shown; a sloping part 22, for allowing the waste liquids to flow toward the drain channels 23. The vessel 5 comprises a plurality of sides 7 which project from the bottom 6 and define a peripheral edge 8. The vessel 5 comprises support structures 9, each comprising a contact portion 10 and projections 29. The contact portions 10 are raised from the bottom 6 by lateral supports 26 and are parallel to the flat portion 21 of the bottom 6. The projections 29 are placed on the contact portions 10 and project out of the contact portions 10 in a direction transverse to the flat portion 21 of the bottom 6.

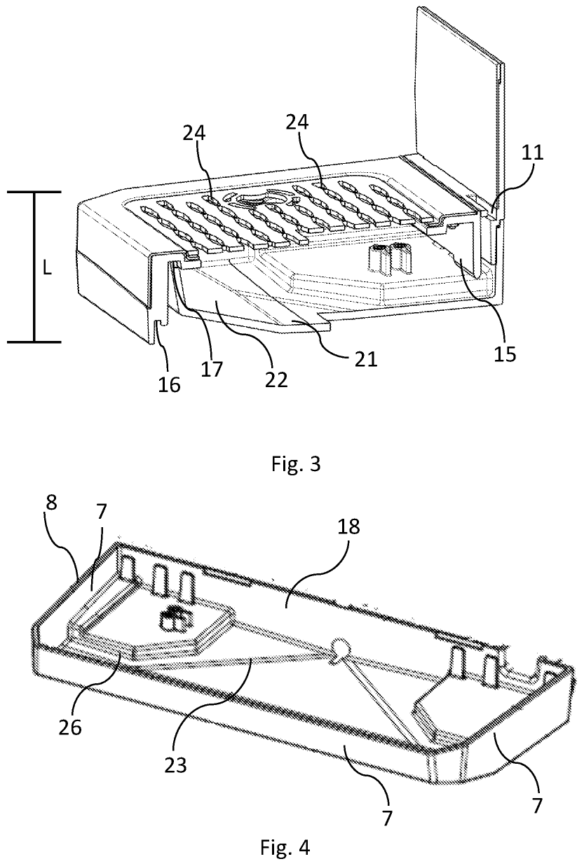

The tray 4 comprises attachment members 11, 15, 32, which comprise a connecting element 32, vessel-attaching members and movable support-attaching members The vessel-attaching members comprise projections 29 and a rear side 18 of the vessel 5 and attach the connecting element 32 to the vessel 5 so that the connecting element 32 will fit between the projections 29 and the rear side 18. The movable support-attaching members attach the movable support 12 to the connecting element 32. The movable support-attaching members comprise first attachment members 11, for example slots, formed on the connecting element 32, as shown in FIG. 3, and second attachment members 15, for example appendages, formed on a wall 19 of the movable support 12. The second attachment members 15 are configured to be coupled with the first attachment members 11 and reversibly attach the movable support 12 to the vessel 5. The kind of attachment between the first attachment members 11 and the second attachment members 15 may be, for example, a snap-fit attachment.

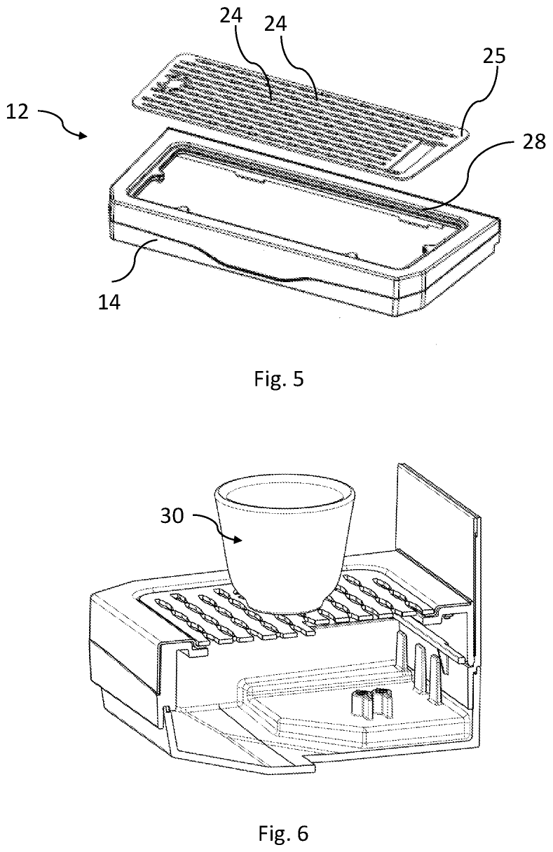

The movable support 12 as shown in FIG. 5 is configured to support the container adapted to receive the beverage being dispensed. The movable support 12 comprises a flat portion 13, parallel to the flat part 21 of the bottom 6 of the vessel 5, on which the container adapted to receive the beverage being dispensed is placed. It shall be noted that the flat part 13 may comprises a seat 28 and a support base 25 that can be reversibly removed from the seat 28. In addition, each second attachment member 15 has one end 20 arranged on an alignment plane parallel to the flat portion 13 of the movable support 12. The support base 25 comprises a plurality of holes 24 to allow waste liquids to flow toward the vessel 5. Furthermore, the movable support 12 comprises walls 14 that project from the flat portion 13.

The movable support 12 comprises, on at least one inner surface, not shown, a first bearing portion 16 and a second bearing portion 17 configured to engage with the peripheral edge 8 of the sides 7 of the vessel 5. In particular, the first 16 and second 17 bearing portions comprise first and second seats respectively, which are configured to engage with the peripheral edge 8 of the sides 7 of the vessel 5. Furthermore, the first and second seats comprise first and second grooves, respectively, configured to engage with the peripheral edge 8 of the sides 7 of the vessel 5.

It shall be noted that the movable support 12 may reversibly alternate between a raised configuration and a lowered configuration. In the raised configuration, as shown in FIG. 2, the first bearing portion 16 of the movable support 12 contacts the peripheral edge 8 of the vessel 5 and the first attachment member 11 and the second attachment member 15 are attached. In the lowered configuration, as shown in FIG. 3, the second bearing portion 17 of the movable support 12 contacts the peripheral edge 8 of the vessel 5 and the second attachment members 15 abut each contact portion 10 of the bearing structures 9 and the projections 29. It shall be noted that the tray 4 in the raised configuration has a height H greater than a height L of the tray 4 in the lowered configuration. Furthermore, the movable support 12 in the lowered configuration is translated in a direction parallel to the bottom 6 away from the rear side 18 attached to the connecting element 32. The raised configuration is preferable for a small container 30, as shown in FIG. 6, such as an espresso cup with a capacity of approximately 70 grams. The lowered configuration is preferable for a large container 31, as shown in FIG. 7, such as a cappuccino cup, having a capacity of about 150 grams, or an Americano cup, having a capacity of about 400 grams.

It should be noted that the wall 19 of the movable support 12, on which the second attachment members 15 are arranged, is the wall that, in the raised configuration, faces the rear side 18 of the vessel 5 attached to the connecting element 32.

Furthermore, the movable support 12, in the lowered configuration , is translated in a direction parallel to the flat part 21 of the bottom 6 away from the the rear side 18 attached to the connecting element 32.

1. A beverage-making machine comprising an outer casing, a beverage dispensing unit and a tray arranged below the beverage dispensing unit, wherein the tray comprises:
a vessel for collecting waste liquids; the vessel comprising a bottom, a plurality of sides projecting from the bottom and defining a peripheral edge, support structures arranged on the bottom, each support structure comprising a contact portion;
a movable support designed to be removably attached to the vessel and configured to support a container adapted to receive the beverage dispensed by the beverage dispensing unit; the movable support comprising a flat portion, walls projecting from the flat portion and a first and a second bearing portions on at least one wall;
attachment members configured to removably attach the movable support to the vessel;
the movable support being able to reversibly alternate between a raised configuration, in which the first bearing portion of the movable support contacts the peripheral edge of the vessel and the attachment members are attached, and a lowered configuration, in which the second bearing portion of the movable support contacts the peripheral edge of the vessel and at least part of the attachment members is released,
wherein the attachment members comprise:
a connecting element which connects the vessel to the movable support;
vessel-attaching members which attach the connecting element to the vessel;
movable support-attaching members which attach the movable support to the connecting element.

2. The beverage-making machine as claimed in claim 1, wherein the vessel-attaching members comprise projections formed on the vessel which couple to a rear side of the vessel so that the connecting element will be arranged between the projections and said rear side of the vessel.

3. The beverage-making machine as claimed in claim 1, wherein the movable support-attaching members comprise first attachment members formed on the connecting element which couple with second attachment members formed on a wall of the movable support.

4. The beverage-making machine as claimed in claim 3, wherein the second attachment members in the lowered configuration abut each contact portion of the bearing structures and the projections.

5. The beverage-making machine as claimed in claim 3, wherein the first attachment members and the second attachment members form a snap fit.

6. The beverage-making machine as claimed in claim 3, wherein the first attachment members comprise slots and the second attachment members comprise appendages configured to couple with said slots.

7. The beverage-making machine as claimed in claim 3, wherein the first attachment members are arranged on the connecting element at a rear side of the vessel.

8. The beverage-making machine as claimed in claim 3, wherein the second attachment members of the movable support are arranged on a wall which, in the raised configuration, faces the rear side of the vessel, which comprises the first attachment members.

9. The beverage-making machine as claimed in claim 3, wherein each second attachment member has one end arranged on an alignment plane substantially parallel to the flat portion of the movable support.

10. The beverage-making machine as claimed in claim 1, wherein the first and second bearing portions comprise first and second seats respectively, which engage with the peripheral edge of the sides of the vessel.

11. The beverage-making machine as claimed in claim 10, wherein the first and second seats comprise first and second grooves which engage with the peripheral edge of the sides of the vessel.

12. The beverage-making machine as claimed in claim 1, wherein the walls of the movable support have an inner surface, on which the first and second bearing portions are placed.

13. The beverage-making machine as claimed in claim 1, wherein the height of the tray in the lowered configuration is less than the height of the tray in the raised configuration; wherein the movable support, in the lowered configuration, is shifted, along a direction parallel to the bottom, away from the rear side with the first coupling members.
